(19) United States
(12) Patent Application Publication
(10) Pub. No.: US 2004/0160086 A1
(43) Pub. Date: Aug. 19, 2004

(54) Carrier beams for houses

(76) Inventor: Paul Kerr, Fort Erie (CA)

Correspondence Address: ARLEN L. OLSEN, SCHMEISER, OLSEN & WATTS, 3 LEAR JET LANE, SUITE 201, LATHAM, NY, 12110, US

(21) Appl. No.: 10/755,124

(22) Filed: Jan. 9, 2004

(30) Foreign Application Priority Data
Jan. 23, 2003 (CA) 2,417,039

(51) Int. Cl. B60P 3/335

(52) U.S. Cl. 296/168; 52/170

(57) ABSTRACT

A carrier beam for distributing the load of a house wherein said beam spans across at least two joists of the house, said beam having a first contact surface adapted to be in contact with at least two joists of the house and said beam having a second contact surface in engagement with the means for supporting the house.

### FIELD OF THE INVENTION

The present invention relates to carrier beams, and more particularly to carrier beams for use in the support and movement of houses.

### DESCRIPTION OF THE PRIOR ART

The manufacturing of completed or partially completed houses within a factory (both of which are referred to herein as a “house” or “houses”), for subsequent transport to the installation location of the house, for example in a subdivision, is well-known. During this process it is necessary to support, lift and move the house, for example from the manufacturing factory to the house foundation or footing or like support system for the house.

Previously, perimeter frames have been manufactured and placed beneath the house, to support the house from the perimeter, for lifting. Reference is made to Canadian Patent Number 2,139,622 (Biffis) describing a base member having a rectangular metal frame affixed to the underside of the house, which is attached through a series of straps and cables and another frame and then to an overhead crane capable of lifting and positioning the house.

The use of a perimeter frame requires the house designer to provide support for the house at those locations which are remote from the perimeter walls. To solve this problem, for example, long joists have been used to span the distance between the perimeter walls, and thereby support those floor locations which are remote from the perimeter. However, long floor joists are expensive and often less than optimal when designing a house, and the use of the perimeter frames of the prior art requires the builder to design floor plans based upon the maximum length of joists available, thereby limiting the flexibility of floor plans available to the house designer.

### SUMMARY OF THE INVENTION

The object of the present invention is to provide a device which permits increased flexibility in house floor plans and to provide support for the house in those regions of the house which are remote from the perimeter wall.

Accordingly, the invention relates to a device for distributing the support provided a to manufactured home comprising a means for supporting the house, a beam for spanning at least two joists of the house, the said beam having a first contact surface adapted to be in contact with at least two joists of the house and the said beam having a second contact surface in engagement with the means for supporting the house.

According to another aspect of the present invention, there is provided a device for distributing the support provided to a house comprising a means for supporting the house; and at least one beam for spanning at least two joists of the house, the said beam having a first contact surface adapted to be in contact with the at least two joists of the house and the said beam having a second contact surface in engagement with the means for supporting the house, wherein the at least one beam is aligned substantially perpendicular to the at least two joists of the house.

According to another aspect of the present invention there is provided a device for distributing the support provided to a house comprising a means for supporting the house; at least one beam for spanning at least two joists of the house, the said beam having a first contact surface adapted to be in contact with the at least two joists of the house and the said beam having a second contact surface in engagement with the means for supporting the house, the at least one beam being aligned substantially perpendicular to the at least two joists of the house, wherein inverted “L” shaped brackets are affixed to each opposed end of the at least one beam, the inverted “L” shaped brackets thus extending a lifting length of the at least one beam wherein, when the house is lowered for placement on a house foundation, a lower surface of each of the inverted “L” shaped brackets affixed on the opposed ends of the at least one beam will contact and engage an upper surface of the house foundation, whereby the inverted “L” shaped brackets will rest on the upper surface of the house foundation, and wherein an upper surface of each of the inverted “L” shaped brackets of the at least one beam receives and supports a rim joist of each opposed side of the house which is placed on the at least one beam.

According to a further aspect of the present invention, there is provided a system for supporting and a house on skate beams for placement on a house foundation comprising providing at least two carrier beams for spanning at least two joists of the house, the said at least two carrier beams having a first contact surface adapted to be in contact with the at least two joists of the house and the said at least two carrier beams having a second contact surface in engagement with and supported by the skate beam; notching at least two carrier beam notches in the house foundation to receive the at least 2 carrier beams; and lowering the house onto the house the house foundation, whereby the at least two carrier beams are received in the at least two carrier beam receiving notches when the house is lowered onto the house foundation.

According to a still further aspect of the present invention, there is provided a system for supporting and a house on skate beams for placement on a house foundation comprising providing at least two carrier beams for spanning at least two joists of the house, the said at least two carrier beams having a first contact surface adapted to be in contact with the at least two joists of the house and the said at least two carrier beams having a second contact surface in engagement with and supported by the skate beam; notching at least two carrier beam notches in the house foundation to receive the at least 2 carrier beams; affixing inverted “L” shaped brackets to each opposed end of each of the at least two carrier beams, the inverted “L” shaped brackets of each of the at least two carrier beams each receiving and supporting a rimjoist of each opposed side of the house which is placed on the at least two carrier beams; and lowering the house onto the house foundation, whereby the at least two carrier beams are received in the at least two carrier beam receiving notches when the house is lowered onto the foundation, and wherein a lower surface of each of the inverted “L” shaped brackets affixed on the opposed ends of the at least two carrier beams will contact and engage an upper surface of the house foundation, whereby the inverted “L” shaped brackets will rest on the upper surface of the house foundation.

According to yet another aspect of the present invention, there is provided a system for supporting and a house on skate beams for placement on a house foundation comprising providing at least two carrier beams for spanning at least two joists of the house, the said at least two carrier beams having a first contact surface adapted to be in contact with the at least two joists of the house and the said at least two carrier beams having a second contact surface in engagement with and supported by the skate beam, and wherein each of the at least two carrier beams are comprised of two or more components which are secured together temporarily; notching at least two carrier beam notches in the house foundation to receive the at least 2 carrier beams; affixing inverted “L” shaped brackets to each opposed end of each of the at least two carrier beams, the inverted “L” shaped brackets affixed to the at least two carrier beams each receiving and supporting a rim joist of each opposed side of the house which is placed on the at least two carrier beams; lowering the house onto the house foundation, whereby the at least two carrier beams are received in the at least two carrier beam receiving notches when the house is lowered onto the foundation, and wherein a lower surface of each of the inverted “L” shaped brackets affixed on the opposed ends of the at least two carrier beams will contact and engage an upper surface of the house foundation, whereby the inverted “L” shaped brackets will rest on the upper surface of the house foundation; and disassembling the two or more components which comprise each of the at least two carrier beams when the house has been placed on the house foundation, whereby the at least two carrier beams can be removed from contact with the at least two joists of the house.

The advantage of the present invention is that it provides a device which provides a more uniform support for the load of the house, permits shorter joists to be used in the manufacturing of house, and provides for a simplified and reusable means of supporting house when they are being moved and installed.

### BRIEF DESCRIPTION OF THE DRAWINGS

A preferred embodiment of the present invention is described below with reference to the accompanying drawings, in which:

FIG. 1 is a drawing of one embodiment of the carrier beams of the present invention supporting a house;

FIG. 2 is a drawing of one embodiment of the single piece carrier beam when the house is being installed onto a foundation;

FIG. 3 is a drawing of one embodiment of a single piece carrier beam when the house is being transported;

FIG. 4 is a view of one embodiment of a multi-part carrier beam in accordance with one aspect of the present invention;

FIG. 5 is an exploded view of the components of an embodiment of a multi-part carrier beam;

FIG. 6 is a cross section view of an embodiment of the two-part carrier beam installed in a house positioned above the foundation; and

FIG. 7 is a cross section view of an embodiment of the two-part carrier beam installed in a house resting on the foundation;

### DESCRIPTION OF THE PREFERRED EMBODIMENT

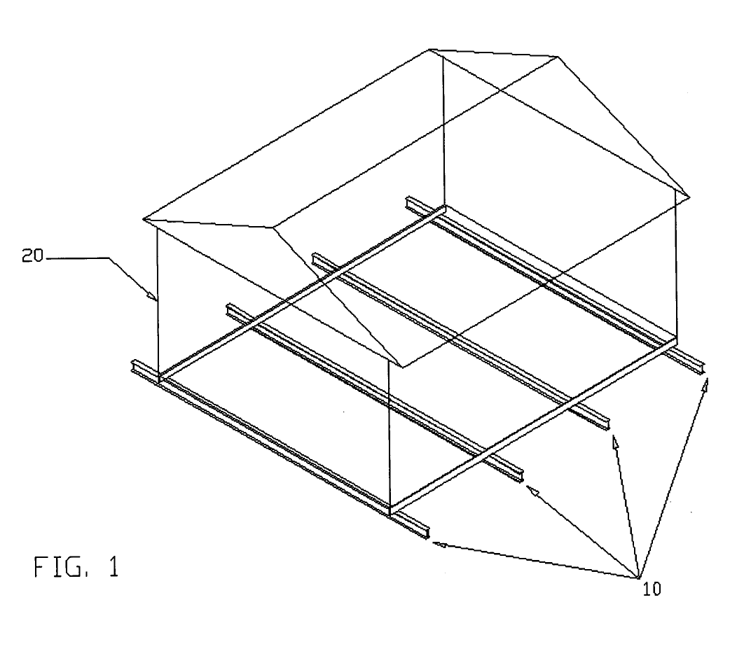

Referring to FIG. 1, an embodiment of the carrier beams 10 of the present invention is illustrated, the carrier beams 10 being positioned underneath the house 20 to efficiently distribute and support the load of the house 20.

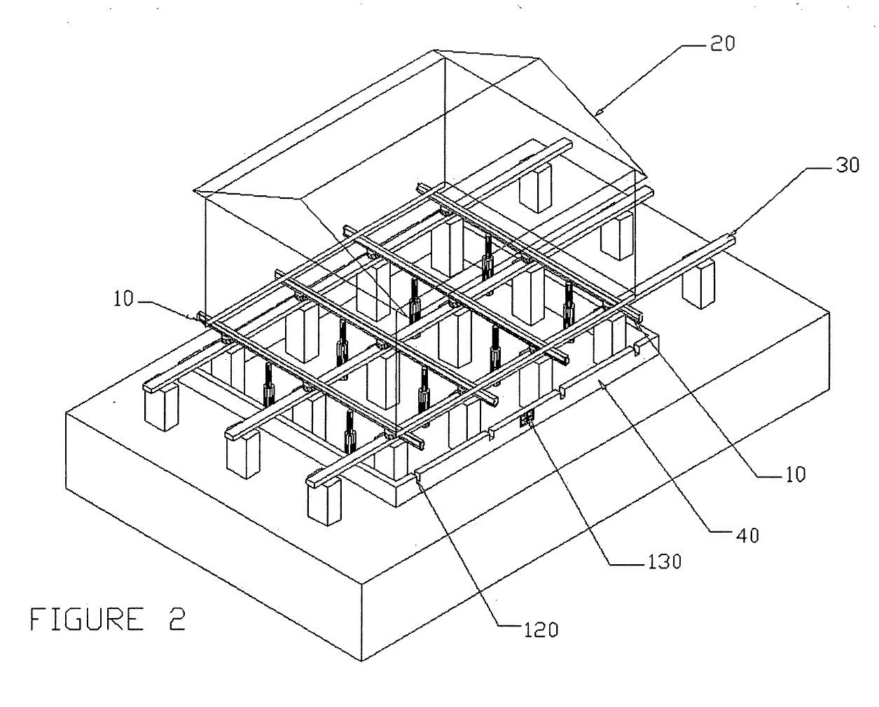

Referring to FIG. 2, when a house 20 is being installed onto a foundation 40, skate beams 30 may be used to support the house 20 and carrier beams 10, and to provide a surface upon which the house 20 and carrier beams 10 may be moved into location above the foundation 40. It is preferred to have the carrier beams 10 aligned substantially perpendicular to the skate beams 30, and it is preferred, when designing a house 20, to have the joists of the house 20 aligned substantially perpendicularly to the carrier beams 10, to the extent this is possible, for improved weight distribution of the house 20.

In a preferred embodiment, as shown in FIG. 1, the carrier beams 10 are temporarily positioned on or attached to the underside of the house 20. The carrier beams 10 are positioned in spaced relation to one another, the spacing between the carrier beams being determined by the loading and structural characteristics of the house 20, and the required support of the house 20 at any particular location.

In the case where the floor of the house 20 is entirely on a single horizontal plane, as shown in FIG. 1, the carrier beams 10 are likewise horizontally aligned, substantially parallel to one another, it being understood that the precise location of each carrier beam 10 will depend upon the unique characteristics of each house.

In the preferred embodiment, as shown in FIG. 1, the carrier beams 10 have a substantially horizontal top surface, the top surface engaging the underside of the house and joists, and a substantially horizontal lower surface upon which the carrier beams 10 may rest when loaded with a house 20, and providing a surface from which the carrier beams 10 and house 20 may be lifted or lowered.

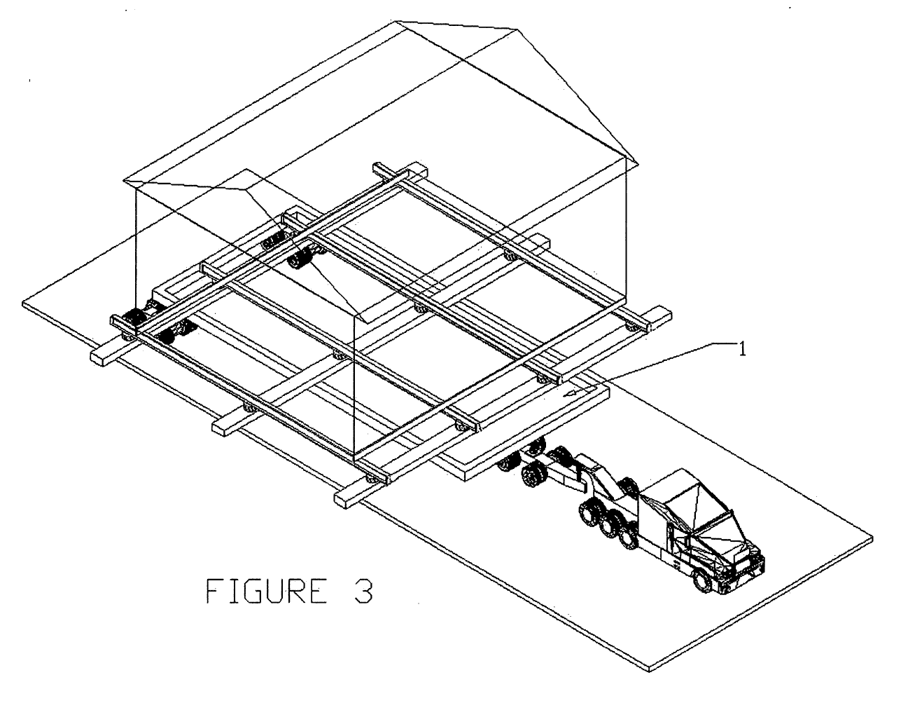

As shown in FIG. 3, when the house is ready for transportation, with the carrier beams positioned beneath the house, the house may then be loaded onto a suitable house transporter 1 for subsequent transportation to the house foundation or elsewhere, depending upon the production and scheduling needs of the factory.

When single piece carrier beams 10 as shown in FIG. 1 are utilized, the carrier beams 10 generally span across the bottom of the house and extend beyond the external walls of the house 20, allowing the carrier beam 10 to receive some of the house 20 load through the rim joists and external walls of the house 20.

When utilizing single piece carrier beams 10 as shown in FIG. 1 to move and support a house, the foundation 40 of the house may require alteration to accommodate the passage of the carrier beam 10 below the top of the foundation wall when the house is being lowered onto the foundation, as the foundation wall would otherwise interfere with the carrier beam's movement as the house is being lowered onto the foundation. For example, as shown in FIG. 2, the foundation wall may need to be cut, or notched, or formed to a sufficient size 130 to allow the carrier beam to be lowered sufficiently as to allow the house to be placed on the top of the foundation, and to allow for the removal of the carrier beam once the house is securely positioned on the foundation 40.

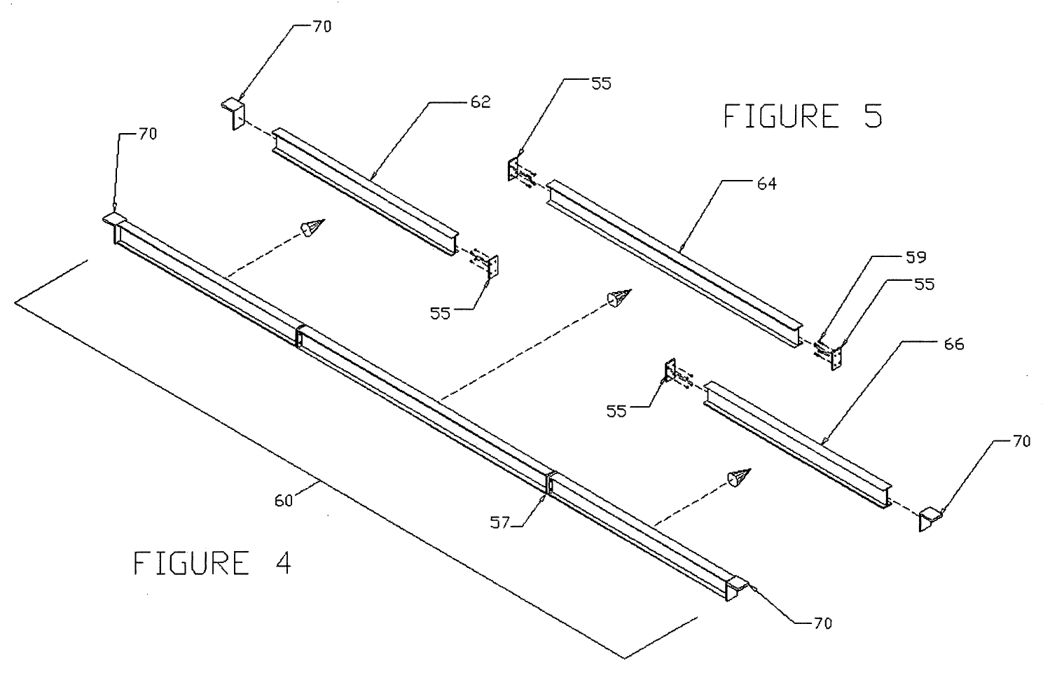

In one embodiment, as an alternative to the solid single piece carrier beams illustrated in FIG. 1, multi-part carrier beams 60, as shown in FIG. 4, may be constructed of two or more components which may be separated for easy disassembly after the house is positioned and lowered onto the foundation. As shown in FIG. 5, this embodiment of the multi-part carrier beam includes parts 62, 64 and 66.

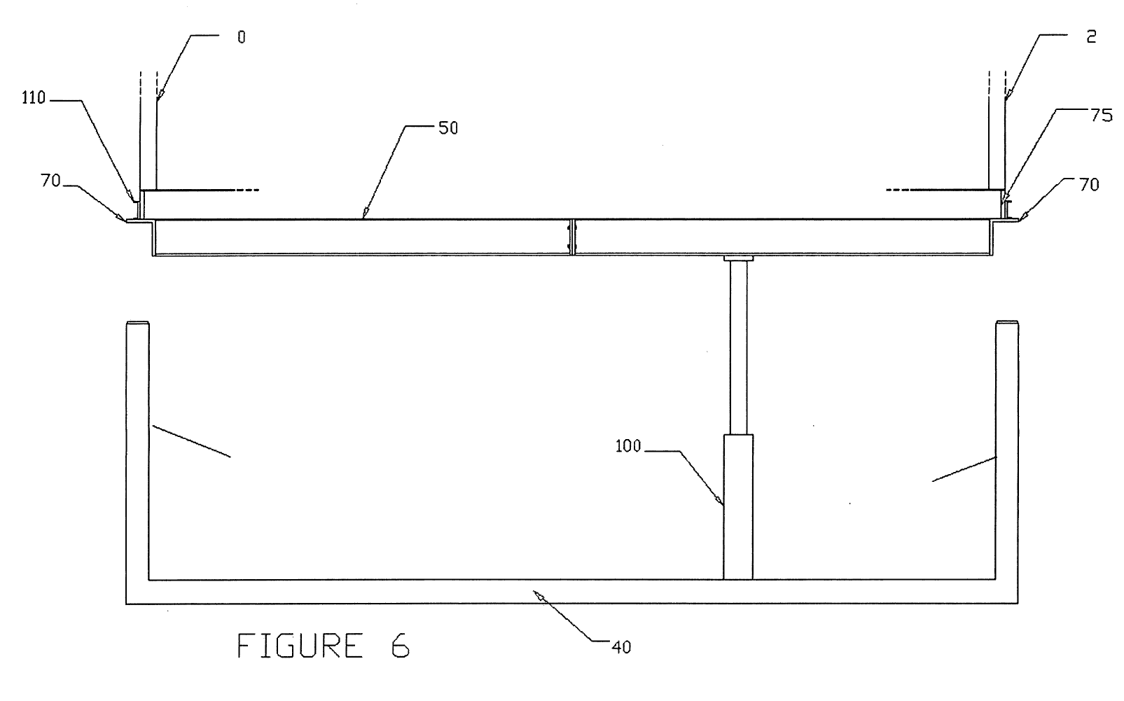

As illustrated in FIG. 6, in the case of the two part carrier beams 50, the combined length of the two part carrier beams is long enough that it extends to within a short distance of the inside surface of both of the foundation walls 80 and 82 at which the carrier beam will be positioned. Similarly, in the case where three part carrier beams are used, the combined length of the three part carrier beams is long enough that it extends to within a short distance of both of the inside surfaces of the foundation walls at which the beam will be positioned. The multi-part carrier beams are joined securely and temporarily in a manner known to a worker skilled in the art. In the preferred embodiment, face plates 55, as shown in FIG. 5, are securely welded 57, as shown in FIG. 4, to those ends of the beam sections which are to be bolted to other carrier beam sections. Holes are drilled in the face plates to receive bolts 59, as shown in FIG. 5, the holes being positioned to ensure that when the two face plates of two beam sections are in alignment with and abutting one another, the holes in the face plates are aligned to receive bolts.

Inverted “L” shaped ears 70, as shown in FIG. 5, are securely affixed, and preferably welded, as shown in FIG. 6, to those ends of the multi-part carrier beams on which no face plate has been welded so that when a multi-part carrier beam is assembled, it has ears extending outwardly on both ends. In the preferred embodiment, the ears are made of steel, having a thickness of between ¾″ and ½″, the horizontal surface measuring approximately 12 inches by 12 inches. These ears 70 effectively extend the lifting length of the carrier beams, permitting the carrier beams, by means of the ears, to receive a significant portion of the load of the house through the rim joist 75 which rests upon the ear, as shown in FIG. 6.

Whether the carrier beams are of the single piece type as shown in FIG. 1, or the multi-piece type of FIGS. 4 and 5, in one embodiment, the house 20 and carrier beams 10 are unloaded from the transporter 1 in close proximity to the foundation 40 and thereafter supported by supported skate beams 30 while the house and carrier beams are being positioned above the foundation 40. In one embodiment, when the house is properly positioned above the foundation, as shown in FIG. 6, jacks 100 installed within the basement of the house 20 may be used to raise the carrier beams and house 20 allowing the skate beams 30 to be removed, whereupon the house 20 and carrier beams 10 can be lowered onto the foundation.

FIG. 6 shows a two-part carrier beam 50 supporting a portion of a house 20 in a position directly above the foundation 40 and suitably aligned so as to allow the house 20 to be lowered onto the foundation 40. FIG. 6 shows a two part carrier beam 50 the ears 70 loaded with exterior walls 90 and 92 of a house 20. The house 20 may additionally be reinforced and supported by a channel 10 temporarily fixedly engaged to the ears 70, the channel abutting the exterior surface of the rim joist 75 of the house for additional support. As shown in FIG. 6, hydraulic or other suitable jacks 100 are positioned on the basement floor or foundation and suitably arranged to engage with and to support in order to lift or lower the two part carrier beam 50 and the house 20.

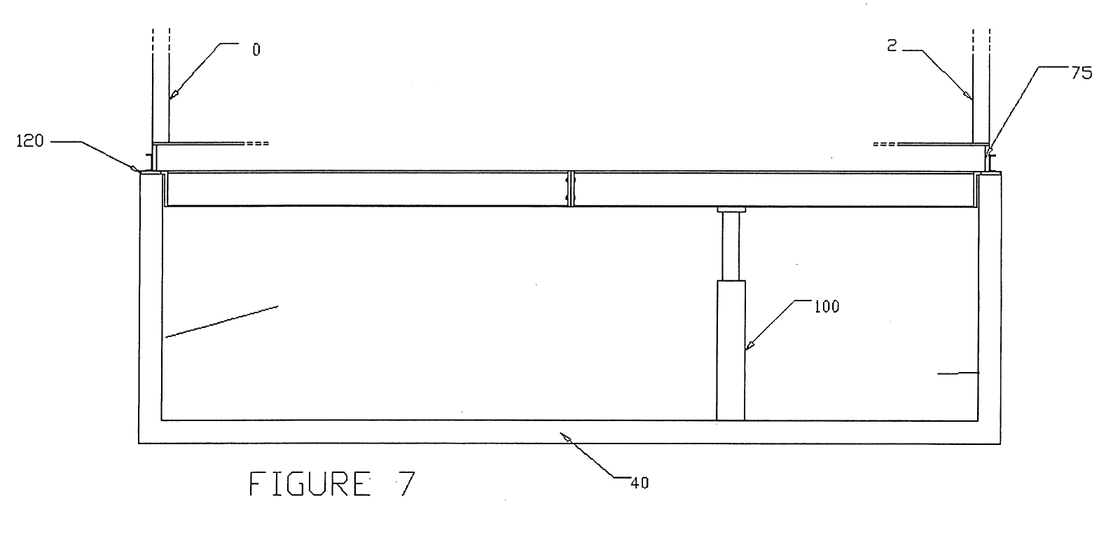

FIG. 7 shows the house 20 in the lowered position, having been suitably lowered from the raised position illustrated in FIG. 6, by means of hydraulic or other suitable jacks 100, until it rests securely on the sill plate 120 (the sill plates having been suitably notched to accommodate and receive the ears 70).

In the case of the multi-part carrier beams, the components of the multi-part carrier beam may then be disassembled one from the other at the face plates and removed from the basement, by the window 130, as shown in FIG. 2, or in any other suitable manner. In the case of the single piece carrier beam, it may be removed through the sufficiently sized cut or notch 120, as shown in FIG. 2, in the foundation wall. In the case of the multi-piece carrier beam, it may be disassembled in the basement of the house and removed in components. The removed carrier beams may then be reused as needed.

It is understood that the number of carrier beams used for a particular house will depend on several factors, including, the loading bearing limits of the carrier beams, the loading and structural characteristics of the house, the size and shape of the house, and whether the underside of the house presents a flat or a multilayered surface.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A device for distributing the support provided to a house comprising:
a means for supporting the house; and
at least one beam for spanning at least two joists of the house, the beam having a first contact surface adapted to be in contact with the at least two joists of the house and the beam having a second contact surface in engagement with the means for supporting the house.

2. A device for distributing the support provided to a house comprising:
a means for supporting the house; and
at least one beam for spanning at least two joists of the house, the said beam having a first contact surface adapted to be in contact with the at least two joists of the house and the said beam having a second contact surface in engagement with the means for supporting the house, wherein the at least one beam is aligned substantially perpendicular to the at least two joists of the house.

3. The device of claim 1, wherein the beam is aligned substantially perpendicular to the at least two joists of the house.

4. The device of any one of claims 1 to 3, wherein the device is temporarily attached to an underside of the at least two joists of the house.

5. The device of any one of claims 1 to 4, wherein the at least one beam extends beyond an external wall of the house.

6. The device of any one of claims 1 to 5, wherein the at least one beam is comprised of two or more components.

7. The device of claim 6, wherein the two or more components comprising the at least one beam are temporarily secured together.

8. The device of claim 6 or 7, wherein face plates are attached to opposed ends of the at least one beam, the face plates having apertures defined therein.

9. The device of claim 8, wherein the two or more components comprising the at least one beam can be connected together by aligning the apertures in the face plates and inserting securing means therethrough.

10. The device of claim 9, wherein the securing means used to connect the two or more components together are bolts.

11. The device of any one of claims 8 to 10, wherein the face plates are welded to the opposed ends of the at least one beam.

12. The device of any one of claims 9 to 11, wherein a length of the at least one beam extends to a distance within an inside surface of each of the opposed ends of a house foundation where the at least one beam will be positioned when the house is lowered onto the house foundation.

13. The device of any one of claims 6 to 12, wherein the two or more components comprising the at least one beam are detachable, whereby disassembly of the at least one beam is possible after the house is lowered and placed onto a house foundation.

14. The device of any one of claims 1 to 6, wherein inverted “L” shaped brackets are affixed to each opposed end of the at least one beam, the inverted “L” shaped brackets thus extending a lifting length of the at least one beam.

15. The device of claim 14, wherein the inverted “L” shaped brackets are welded to each of the opposed ends of the at least one beam.

16. The device of claim 14, wherein the inverted “L” shaped brackets are bolted to each of the opposed ends of the at least one beam.

17. The device of any one of claims 14 to 16, wherein the inverted “L” shaped brackets are made of steel, and have a thickness of from ¾′ to 1½′.

18. The device of any one of claims 14 to 17, wherein an upper horizontal surface of the inverted “L” shaped brackets measures from 12 inches long by 12 inches wide.

19. The device of any one of claims 14 to 18, wherein, when the house is lowered for placement on a house foundation, a lower surface of each of the inverted “L” shaped brackets affixed on the opposed ends of the at least one beam will contact and engage an upper surface of the house foundation, whereby the inverted “L” shaped brackets will rest on the upper surface of the house foundation.

20. The device of any one of claims 14 to 19, wherein an upper surface of each of the inverted “L” shaped brackets of the at least one beam receives and supports a rim joist of each opposed side of the house which is placed on the at least one beam.

21. The device of claim 20, wherein a channel is temporarily engaged to the upper surface of each of the inverted “L” shaped brackets, whereby the channel affixed on the upper surfaces of each of the inverted “L” shaped brackets will abut an exterior surface of the rim joists of each opposed side of the house which is placed on the at least one beam.

22. A device for distributing the support provided to a house comprising:
a means for supporting the house;
at least one beam for spanning at least two joists of the house, the said beam having a first contact surface adapted to be in contact with the at least two joists of the house and the said beam having a second contact surface in engagement with the means for supporting the house, the at least one beam being aligned substantially perpendicular to the at least two joists of the house, wherein inverted “L” shaped brackets are affixed to each opposed end of the at least one beam, the inverted “L” shaped brackets thus extending a lifting length of the at least one beam wherein, when the house is lowered for placement on a house foundation, a lower surface of each of the inverted “L” shaped brackets affixed on the opposed ends of the at least one beam will contact and engage an upper surface of the house foundation, whereby the inverted “L” shaped brackets will rest on the upper surface of the house foundation, and wherein an upper surface of each of the inverted “L” shaped brackets of the at least one beam receives and supports a rim joist of each opposed side of the house which is placed on the at least one beam.

23. A system for supporting a house on skate beams for placement on a house foundation comprising:
providing at least two carrier beams for spanning at least two joists of the house, the said at least two carrier beams having a first contact surface adapted to be in contact with the at least two joists of the house and the said at least two carrier beams having a second contact surface in engagement with and supported by the skate beam;
notching at least two carrier beam notches in the house foundation to receive the at least 2 carrier beams; and
lowering the house onto the house the house foundation, whereby the at least two carrier beams are received in the at least two carrier beam receiving notches when the house is lowered onto the house foundation.

24. The system of claim 23, wherein the at least two carrier beams are positioned in spaced relation to each other so as to support the house placed thereon, the at least two carrier beams being placed in a substantially parallel relationship.

25. The system of claim 23 or 24, wherein the at least two carrier beams each have a substantially horizontal upper surface for engaging an underside of the at least two joists of the house, and a substantially horizontal lower surface upon which the at least two carrier beams may be supported or engaged by the skate beam.

26. A system for supporting a house on skate beams for placement on a house foundation comprising:
providing at least two carrier beams for spanning at least two joists of the house, the said at least two carrier beams having a first contact surface adapted to be in contact with the at least two joists of the house and the said at least two carrier beams having a second contact surface in engagement with and supported by the skate beam;
notching at least two carrier beam notches in the house foundation to receive the at least 2 carrier beams;
affixing inverted “L” shaped brackets to each opposed end of each of the at least two carrier beams, the inverted “L” shaped brackets of each of the at least two carrier beams each receiving and supporting a rim joist of each opposed side of the house which is placed on the at least two carrier beams; and
lowering the house onto the house foundation, whereby the at least two carrier beams are received in the at least two carrier beam receiving notches when the house is lowered onto the foundation, and wherein a lower surface of each of the inverted “L” shaped brackets affixed on the opposed ends of the at least two carrier beams will contact and engage an upper surface of the house foundation, whereby the inverted “L” shaped brackets will rest on the upper surface of the house foundation.

27. A system for supporting a house on skate beams for placement on a house foundation comprising:
providing at least two carrier beams for spanning at least two joists of the house, the said at least two carrier beams having a first contact surface adapted to be in contact with the at least two joists of the house and the said at least two carrier beams having a second contact surface in engagement with and supported by the skate beam, and wherein each of the at least two carrier beams are comprised of two or more components which are secured together temporarily;
notching at least two carrier beam notches in the house foundation to receive the at least 2 carrier beams;
affixing inverted “L” shaped brackets to each opposed end of each of the at least two carrier beams, the inverted “L” shaped brackets affixed to the at least two carrier beams each receiving and supporting a rim joist of each opposed side of the house which is placed on the at least two carrier beams;
lowering the house onto the house foundation, whereby the at least two carrier beams are received in the at least two carrier beam receiving notches when the house is lowered onto the foundation, and wherein a lower surface of each of the inverted “L” shaped brackets affixed on the opposed ends of the at least two carrier beams will contact and engage an upper surface of the house foundation, whereby the inverted “L” shaped brackets will rest on the upper surface of the house foundation; and
disassembling the two or more components which comprise each of the at least two carrier beams when the house has been placed on the house foundation, whereby the at least two carrier beams can be removed from contact with the at least two joists of the house.

28. The system of any one of claims 23 to 27, wherein at least 4 carrier beam notches are notched in the house foundation to receive the at least 2 carrier beams when the house is lowered onto the house foundation.
